(19) United States
(12) Patent Application Publication
(10) Pub. No.: US 2018/0321129 A1
(43) Pub. Date: Nov. 8, 2018

(54) METHOD OF DETECTING NEUTROPHIL EXTRACELLULAR TRAPS

(71) Applicant: Siemens Healthcare Diagnostics Products GmbH, Marburg (DE)

(72) Inventor: Gottfried Prechtl, Zellerndorf (AT)

(21) Appl. No.: 15/773,551

(22) PCT Filed: Nov. 3, 2016
(86) PCT No.: PCT/EP2016/076521

§ 371 Date: May 3, 2018

(30) Foreign Application Priority Data
Nov. 4, 2015 (EP) 15192865.2

(51) Int. Cl. G01N 15/14; G01N 15/06

(52) U.S. Cl. CPC G01N 15/1434; G01N 2015/0065; G01N 15/1459; G01N 15/06

(57) ABSTRACT

The invention relates to a method of detecting neutrophil extracellular traps in a sample of a biofluid, wherein the sample of the biofluid is supplied with a nucleic acid-selective dye, wherein, after the staining, a multitude of optical, particle-related measurements is determined in the sample within the absorption range of the dye, in each case as a tuple of a measurement of a first optical feature and a second optical feature, wherein measurements of the first optical feature are selected within a sub-range of all measured values of the first optical feature and those of the second optical feature within a sub-range of all measured values of the second optical feature, and wherein the number of selected measurements for detection of the neutrophil extracellular traps is compared to a predetermined borderline value.

### CROSS REFERENCE TO RELATED APPLICATIONS

This is a 371 of PCT/EP2016/076521, filed Nov. 3, 2016, which claims priority to European Patent Application No. EP 15192865.2, filed Nov.4, 2015, the disclosures of which are hereby incorporated by reference herein in their entireties for all purposes.

### FIELD

The invention relates to a method for detecting, in particular detecting in a fully automated manner, neutrophil extracellular traps in a sample of a biofluid, in particular in a blood sample. The invention further relates to an analysis system for carrying out, in particular carrying out in a fully automated manner, said method.

### BACKGROUND

Neutrophils have various mechanisms by means of which they can eliminate bacteria in the peripheral bloodstream. These include phagocytosis, in which the neutrophils take up and digest bacteria. Furthermore, neutrophils can release bactericidal toxins in order to kill bacteria. A further mechanism of neutrophils for eliminating bacteria is the shaping and release of networks of DNA threads with proteins, which form an extracellular, fibrous matrix, which are referred to as neutrophil extracellular traps (NETs) and are used to catch bacteria. The caught bacteria are then killed by means of bactericidal toxins which are released by the neutrophils into the neutrophil extracellular traps. After the bacteria have been killed, the neutrophil extracellular traps are degraded and disposed of. An incomplete disposal of neutrophil extracellular traps is associated with various autoimmunological symptoms. Furthermore, it is assumed that neutrophil extracellular traps are also one of the reasons for the rise in the risk of thrombosis in the event of infections, since thrombocytes can also be caught in neutrophil extracellular traps and the risk of thrombosis can thus rise. Furthermore, neutrophil extracellular traps are associated with infectious, inflammatory, autoimmunological and thrombotic disease, such as, for example, sepsis, preeclampsia, malaria and lupus erythematosus.

Neutrophil extracellular traps can be detected by means of electron-microscopy or light-microscopy analysis methods. Furthermore, it is possible to detect them by means of antibody-based detection methods, for example using an enzyme linked immunosorbent assay (ELISA) or by means of a fluorometric flow-cytometer method; see, for example, Gavillet, Mathilde, et al. “Flow cytometric assay for direct quantification of neutrophil extracellular traps in blood samples”. American Journal of Hematology, 2015. However, the latter has the disadvantage that specific antibodies are required to this end.

The detection of neutrophil extracellular traps can, for example, help to make a relevant diagnosis in the case of autoimmunological symptoms, which are associated with an altered, for example increased, concentration of neutrophil extracellular traps. Furthermore, the detection of neutrophil extracellular traps can, in particular, help to make possible an improved estimation of the risk of thrombosis, for example in the case of existing infections. In the case too of pulmonary diseases and metastasizing cancers, neutrophil extracellular traps appear to play an important role. The detection of neutrophil extracellular traps in samples of biofluids, in particular in blood samples, should be carried out in a fully automated manner if possible. Currently, this is only possible with complicated antibody-based detection methods.

### SUMMARY

It is an object of the invention to provide a simplified method for detecting neutrophil extracellular traps in samples of a biofluid, which method can also be carried out in an automated manner using optical analysis systems and which method does not require antibodies.

According to the invention, this object is achieved in that a dye selective for nucleic acid is supplied to a sample of the biofluid, which dye stains in this case DNA (deoxyribonucleic acid), wherein a multiplicity of optical, particle-related measurement values is determined in the sample after staining within the absorption range of the dye, in each case as a tuple composed of refractive index and adsorptance, wherein measurement values with an adsorptance within a subregion of all measured values of the adsorptance and with a refractive index within a subregion of all measured values of the refractive index are selected, and wherein the number of selected measurement values is used in order to detect the neutrophil extracellular traps.

In this connection, the invention is based on the consideration that, by means of a cytometric method carried out in flow geometry for example, it is possible, in a comparison of the two-dimensional measurement values composed of absorptance and associated refractive index in a cytogram, for the neutrophil extracellular traps to be separated comparatively easily from reticulated thrombocytes, ripe thrombocytes and other particles, for example erythrocytes and fragments of erythrocytes, in relevant refractive index regions.

Since neutrophil extracellular traps contain a very large amount of nucleic acid, their absorptance differs, after selective staining, from ripe thrombocytes, which contain little nucleic acid. In this respect, it is possible, in a cytogram composed of absorptance and refractive index, for a subregion with relatively high absorptance to be assigned to the measurement values originating from neutrophil extracellular traps. The nucleic acid present in the neutrophil extracellular traps is DNA. The nucleic acid present in the ripe thrombocytes is RNA.

On the other hand, erythrocytes and fragments of erythrocytes exhibit, owing to their hemoglobin content, a higher refractive index compared to neutrophil extracellular traps, meaning that a subregion of relatively low refractive index can be assigned to the measurement values originating from neutrophil extracellular traps. Furthermore, reticulated thrombocytes, which still contain a relatively large amount of nucleic acid, likewise exhibit a higher refractive index compared to neutrophil extracellular traps. The nucleic acid present in the reticulated thrombocytes is RNA.

In this respect, it is possible, from a cytometric record composed of absorptance and refractive index, for a subregion of measurement values to be assigned to the neutrophil extracellular traps. The number of appropriately selected measurement values is then used for the determination of the concentration of the neutrophil extracellular traps. In this connection, it has become apparent that the measurement is largely interference-free with respect to small blood cells, such as, for example, small erythrocytes, and cell fragments.

A cytometric measurement, in particular a two-dimensional cytometric measurement, of optical particle-relevant features is part of the standard method of automated optical analysis systems for biofluids. However, to date, the staining of nucleic acids by means of a dye is mainly carried out for the determination of the number or the fraction of reticulocytes. The invention differs therefrom, however.

The invention thus provides, in particular, a method for detecting neutrophil extracellular traps in a sample of a biofluid, in particular in a blood sample, wherein a dye selective for nucleic acid is supplied to the sample of the biofluid, wherein a multiplicity of optical, particle-related measurement values is determined in the sample after staining within the absorption range of the dye, in each case as a tuple composed of a measurement value of a first optical feature and of a second optical feature, wherein measurement values of the first optical feature within a subregion of all measured values of the first optical feature and of the second optical feature within a subregion of all measured values of the second optical feature are selected, and wherein the number of selected measurement values is compared with a predetermined limit value in order to detect the neutrophil extracellular traps. Neutrophil extracellular traps are detected in the sample of the biofluid when the number of selected measurement values is greater than or equal to the predetermined limit value. No neutrophil extracellular traps are detected in the sample when the number of selected measurement values is less than the predetermined limit value.

The predetermined limit value is, for example, ascertained by appropriate measurements on a plurality of samples which contain neutrophil extracellular traps in different, known concentrations. Advantageously, the concentrations are, in this connection, within the clinically relevant concentration ranges for neutrophil extracellular traps. In this connection, the plurality of samples advantageously also comprises samples which do not contain neutrophil extracellular traps and/or contain neutrophil extracellular traps only in a very minimal number.

Preferably, the method according to the invention is a flow-cytometry method.

The first and the second optical feature are, for example, particle-related scattered-light intensities, refractive indices, light-intensity reductions, absorptances, transmittances, degrees of fluorescence, or reflectances.

In a preferred configuration, the first optical feature is a scattered-light intensity and/or the second optical feature is the light-intensity reduction, preferably the absorptance.

In a further preferred configuration, the scattered-light intensity is the intensity of the light deflected by the sample by an angle within an angle range from 5 to 15 degrees, preferably from 5 to 8 degrees.

In a further preferred configuration, the refractive index is ascertained by means of the scattered-light intensity or the scattered-light intensity is used as a measure of the refractive index, wherein the refractive index is the first optical feature.

If, in configurations of the invention, reference is made to a scattered-light intensity or to scattered-light intensities, further configurations of the invention are obtained by the scattered-light intensity being replaced by a refractive index or by the scattered-light intensities being replaced by refractive indices.

In a further advantageous configuration, the upper limit of the subregion of the scattered-light intensity, in particular variable over the absorptance, is chosen such that the scattered-light intensities of the neutrophil extracellular traps are separated from scattered-light intensities of the reticulated thrombocytes and of the erythrocytes and fragments of erythrocytes, with the result that an interference is excluded or at least minimized. Usually, the scattered-light intensities of erythrocytes and reticulated thrombocytes, on the one hand, and of neutrophil extracellular traps, on the other, are sufficiently far apart, with the result that an appropriate limit can be easily defined by considering corresponding scattered-light intensities. Such scattered-light intensities can, in the case of automated analysis systems, be gathered from corresponding output channels.

In a further advantageous configuration, the lower limit of the subregion of the light-intensity reduction, in particular variable over the scattered-light intensity, is chosen such that light-intensity reductions of neutrophil extracellular traps are separated from light-intensity reductions of the thrombocytes, with the result that an interference is excluded or at least minimized. Usually, the light-intensity reductions of mature thrombocytes, on the one hand, and of neutrophil extracellular traps, on the other hand, are sufficiently far apart, with the result that an appropriate limit can be easily defined by considering corresponding light-intensity reductions. Such light-intensity reductions can, in the case of automated analysis systems, be gathered from corresponding output channels. Preferably, the light-intensity reduction is the absorptance.

Furthermore, the invention also allows a largely interference-free recording of the neutrophil extracellular traps with respect to other particles which are usually situated in the peripheral blood, which have, or cause, a comparable light-intensity reduction, preferably a comparable absorptance, or a comparable scattered-light intensity, preferably a comparable refractive index, to the neutrophil extracellular traps. It has become apparent that such particles exhibit, compared to the neutrophil extracellular traps, a higher refractive index and/or a different distribution pattern in the absorptance, or exhibit accordingly a higher scattered-light intensity and/or a different distribution pattern with regard to the light-intensity reduction.

Preferably, the lower limit of the subregion of the scattered-light intensity, in particular variable over the light-intensity reduction or the absorptance, is chosen such that at least 80%, preferably at least 90%, particularly preferably at least 95% of the measurement values which trace back to neutrophil extracellular traps have a larger scattered-light intensity than the scattered-light intensity at which the limit runs. Preferably, the lower limit of the subregion of the scattered-light intensity is, in this connection, formed by its lower recording limit.

Preferably, the upper limit of the subregion of the light-intensity reduction or of the absorptance, in particular variable over the scattered-light intensity or the refractive index, is chosen such that at least 80%, preferably at least 90%, particularly preferably at least 95% of the measurement values which trace back to neutrophil extracellular traps have a smaller light-intensity reduction or a smaller absorptance than the light-intensity reduction or the absorptance at which the limit runs. Preferably, the upper limit of the subregion of the light-intensity reduction or of the absorptance is, in this connection, defined by the maximally measurable light-intensity reduction or by the maximally measurable absorptance.

In a further advantageous configuration, the limits of the subregion of the light-intensity reduction, in particular variable over the scattered-light intensity, and of the scattered-light intensities, in particular variable over the light-intensity reduction, are chosen such that at least 80%, preferably at least 90%, particularly preferably at least 95% of the measurement values which trace back to neutrophil extracellular traps are within the subregion defined by the chosen limits. Preferably, the light-intensity reduction is the absorptance and/or the scattered-light intensity is the refractive index.

The measurement values which comprise in each case a tuple composed of light-intensity reduction and scattered-light intensity are ascertained by, for example, recording in a time-resolved manner in flow geometry the scattering, reflection and/or transmission of a light beam, in particular a laser beam, that is caused in each case by particles situated in the measurement volume. From the optical parameters measured in various measurement geometries, what are then ascertained as measurement values are, in each case, a tuple composed of optical features, in particular also refractive index and absorptance, which allow conclusions to be drawn about the particles present in the biofluid as dispersed phase. Here, this so-called flow cytometry is an established measurement method of modern optical analysis systems for analyzing biofluids, as are, for example, used to create a blood count or the like in a fully automated manner. Preferably, the above-described method is therefore carried out, in particular in a fully automated manner, in an analysis system for the optical analysis of a sample of a biofluid. Oxazine 750 is preferably used as a suitable dye. Oxazine 750 is frequently used for staining nucleic acid and is used in the present case for staining DNA of the neutrophil extracellular traps. Further nucleic acid-selective dyes are, for example, methylthioninium chloride, ethidium bromide and acridine orange. Preferably, the light-intensity reduction is the absorptance and/or the scattered-light intensity is the refractive index.

Preferably, the dye selective for nucleic acid that is supplied to the sample of the biofluid is a non-antibody-associated dye. Particularly preferably, the dye is a non-antibody-bound dye.

Hypochromic erythrocytes, i.e., erythrocytes having a comparatively low hemoglobin content, reticulated thrombocytes and mature thrombocytes can, however, each exhibit in regions of the absorptance a refractive index which is in the proximity of the scattered-light intensities of neutrophil extracellular traps. Therefore, in an advantageous variant, the frequency distribution of the measured scattered-light intensities is ascertained and, herein, a population of the erythrocytes, of the reticulated thrombocytes and of the mature thrombocytes is identified in a region of relatively high scattered-light intensities and a population of the neutrophil extracellular traps is identified in a region of relatively low scattered-light intensities. As upper limit of the subregion of the scattered-light intensity, a scattered-light intensity is then chosen from a region between the two respective populations. This ensures that a possible interference of measurement values of neutrophil extracellular traps and measurement values of erythrocytes, reticulated thrombocytes and mature thrombocytes is avoided to the greatest possible extent. An analogous procedure can be carried out with regard to the choice of limits with regard to the scattered-light intensities of neutrophil extracellular traps and other particles. An analogous procedure can likewise be carried out with regard to the choice of limits with regard to the light-intensity reduction caused by neutrophil extracellular traps and other particles, for example erythrocytes, reticulated thrombocytes and/or mature thrombocytes, in order to largely avoid possible interferences of measurement values of neutrophil extracellular traps with the respective other particles in the sample. Preferably, the light-intensity reduction is the absorptance and/or the scattered-light intensity is the refractive index.

In a further preferred configuration of the method, the absorptances and/or refractive indices of reticulated thrombocytes, mature thrombocytes and/or erythrocytes, or the light-intensity reductions and/or scattered-light intensities which trace back to these cells, are measured in the sample of the biofluid, in particular in an automated manner. This has the advantage that, in addition to the detection of the neutrophil extracellular traps, the sample can also be characterized with regard to further particles.

In a further preferred configuration of the method, the number of selected measurement values is used for the qualitative and/or for the quantitative detection of the neutrophil extracellular traps. This has the advantage that the sample can be characterized more exactly with respect to the neutrophil extracellular traps present therein.

In a further preferred configuration of the method, the number of selected measurement values is used for the determination of the concentration of the neutrophil extracellular traps. The concentration of neutrophil extracellular traps can, for example, be specified in the units number of neutrophil extracellular traps per microliter of sample of the biofluid. In this connection, it is, for example, possible for the number of neutrophil extracellular traps to be specified in any desired unit which is directly proportional to the number of particle-based measurement values which are assigned to neutrophil extracellular traps. For example, the unit in which the number of neutrophil extracellular traps is specified can be calibrated by means of a suitable sample which contains a predetermined number of neutrophil extracellular traps. This has the advantage that the sample can be characterized particularly more exactly with respect to the neutrophil extracellular traps present therein.

In a preferred embodiment of the method, the sample does not, in the detection of the neutrophil extracellular traps, contain any antibodies added to the sample.

In a preferred embodiment of the method, the sample contains neutrophil extracellular traps.

In a further preferred embodiment of the method, the detection of the neutrophil extracellular traps aids in the diagnosis of an infectious, inflammatory, autoimmunological and/or thrombotic disease. Preferably, the diseases are sepsis, diseases with an increased risk of thrombosis and/or various autoimmunology diseases.

In a further preferred embodiment of the method, the detection of the neutrophil extracellular traps is used in the diagnosis of an infectious, inflammatory, autoimmunological and/or thrombotic disease. Preferably, the diseases are sepsis, diseases with an increased risk of thrombosis and/or various autoimmunology diseases.

The invention further provides an analysis system for the optical analysis of a sample of a biofluid, in particular a blood sample, which is setup and designed to carry out a method of the above-described type, in particular in a fully automated manner.

In a preferred embodiment, the analysis system comprises a flow cytometer.

The term “biofluid” refers to a human or animal body fluid, in particular blood, which can contain neutrophil extracellular traps.

“Detection of neutrophil extracellular traps” means any form of the qualitative or quantitative detection of the presence of neutrophil extracellular traps. This can include, in particular, also the implicit and/or explicit determination of the concentration of neutrophil extracellular traps.

In the case of a quantitative detection, what is measured is the amount, the concentration and/or the activity of the analyte, in this case the neutrophil extracellular traps, in the sample. The term “quantitative detection” also encompasses semiquantitative methods which can record only the approximate amount, concentration and/or activity of the analyte in the sample or can be used only to provide a relative indication of amount, concentration or activity. A qualitative detection is understood to mean the detection of the presence of the analyte in the sample in the first place or the indication that the amount, concentration or activity of the analyte in the sample is below or above a certain threshold value or two or more certain threshold values.

### BRIEF DESCRIPTION OF THE DRAWINGS

Exemplary embodiments of the invention will be more particularly elucidated on the basis of a drawing, where:

FIG. 1 shows schematically an automated optical analysis system for samples of a biofluid,

FIG. 2 shows schematically details of the structure of the optical analysis system,

FIGS. 3, 4, and 5 each show a cytogram, where the scattered-light intensity (B) is plotted against the absorptance (A).

### DETAILED DESCRIPTION

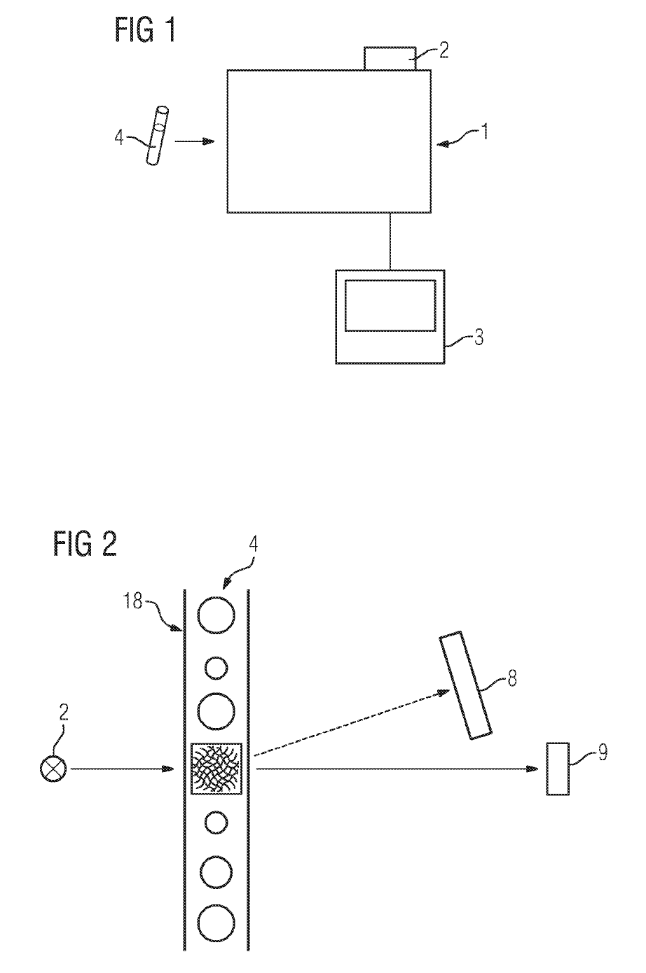

FIG. 1 depicts schematically an optical analysis system 1 for carrying out an automated analysis of the sample of a biofluid. Here, the analysis system 1 comprises a light source 2, in particular a laser, which transilluminates a sample volume. A multiplicity of optical features, such as, in particular, particle-based scattered-light intensities, refractive indices, light-intensity reductions, absorptances, transmittances, reflectances, etc., are recorded by observing the laser light rushing through a sample volume in scattering geometry, reflection geometry, transmission geometry, etc. Furthermore, an output unit 3 is assigned to the analysis system 1. Via the output unit 3, it is possible, via a multiplicity of output channels, to output, depict or further evaluate the optical features ascertained in each case. Via the output unit 3, it is, in particular, possible to output a complete blood count in table form containing an output of all relevant data including the fraction of reticulated thrombocytes. For the analysis, a sample 4 of a biofluid, in particular a blood sample, is accordingly supplied to the analysis system 1. The subsequent evaluation is done in a fully automated manner including any supply of auxiliaries, dyes, etc.

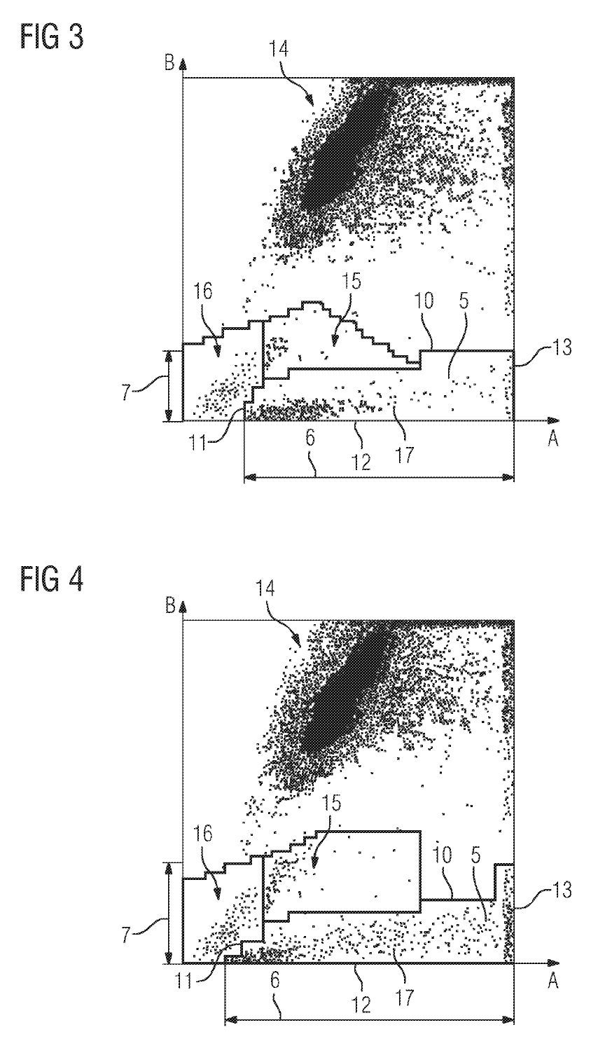

FIG. 2 depicts details of the structure of the optical analysis system 1. Light from the light source 2, which is designed as a semiconductor laser and emits light of a wavelength of 670 nm, is guided onto the sample 4. The sample 4 is situated in a capillary 18, which is designed as a through-flow capillary. Situated in the capillary 18 are various particles, which are depicted as circles with different radii or as a network, with the network symbolizing a neutrophil extracellular trap. The sample volume is transilluminated and the light interacts with the sample. A portion of the light falls without change in direction (onto the second detector 9, and a further portion of the light is deflected by the sample at an angle of from 5 to 15 degrees and hits the first detector 8. Signals from the second detector 9 are used to ascertain the absorptance of individual particles in the sample 4. Signals of the first detector 8 are used to ascertain the scattered-light intensity, which can be attributed to individual particles in the sample 4.

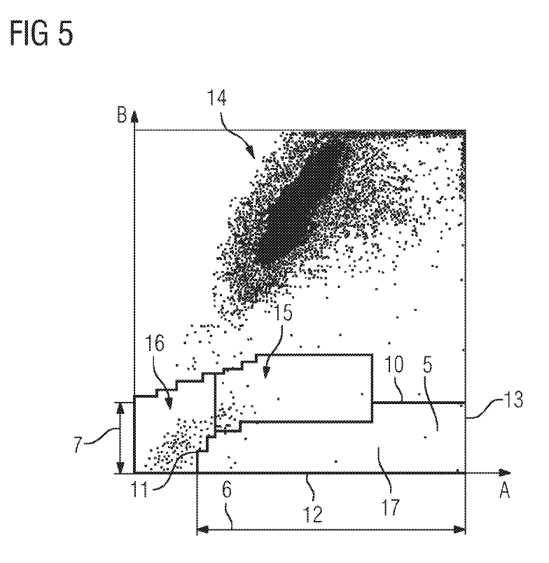

FIG. 3, FIG. 4 and FIG. 5 each depict a cytogram in which the scattered-light intensity (B) is plotted against the absorptance (A). The recorded particle-based measurement values, which comprise in each case a tuple composed of scattered-light intensity (B) and absorptance (A), are inputted as the result of an automated analysis method. From a region 5 of selective measurement values, it is possible to gather the number of neutrophil extracellular traps. Said region comprises a subregion 6 of the measured absorptances and a subregion 7 of the measured scattered-light intensities. Here, the region 5 is, in particular, partitioned off with respect to the measurement values of erythrocytes and reticulated thrombocytes by an upper limit 10 of the scattered-light intensity and with respect to mature thrombocytes by a lower limit 11 of the absorptance. Furthermore, the region 5 is enclosed by a lower limit 12 of the scattered-light intensity and an upper limit of the absorption 13. Via the drawn-in limits, it is possible to determine the number of neutrophil extracellular traps in a manner that is interference-free to the greatest possible extent. To determine the concentration of neutrophil extracellular traps, the determined number of neutrophil extracellular traps is divided by the volume of the sample of the biofluid 4 in which the number was determined. The concentration of neutrophil extracellular traps is specified in the units number of neutrophil extracellular traps per microliter of sample of the biofluid 4. In this connection, the number of neutrophil extracellular traps is specified in any desired unit which is directly proportional to the number of particle-based measurement values which are assigned to neutrophil extracellular traps.

In the cytogram, it is possible to identify and to distinguish with distinct identifiability and distinguishability measurement values of various populations of particles, in particular a large population of erythrocytes 14, a relatively small population of reticulated thrombocytes 15, a population of mature thrombocytes 16 and a population of neutrophil extracellular traps 17.

The limit 10 is ascertained on the basis of a frequency distribution of the measured scattered-light intensities and, herein, a population of the erythrocytes, of the reticulated thrombocytes and of the mature thrombocytes is identified in a region of relatively high scattered-light intensities and a population of the neutrophil extracellular traps is identified in a region of relatively low scattered-light intensities. As upper limit 10 of the subregion of the scattered-light intensity, a scattered-light intensity is then chosen from a region between the two respective populations.

The limit 11 is ascertained on the basis of a frequency distribution of the measured absorptances and, herein, a population of the erythrocytes, of the reticulated thrombocytes and of the mature thrombocytes is identified in a region of relatively low absorptances and a population of the neutrophil extracellular traps is identified in a region of relatively high absorptances. As lower limit 11 of the subregion of the absorptance, an absorptance is then chosen from a region between the two respective populations.

The limit 12 is chosen such that at least 80%, preferably at least 90%, particularly preferably at least 95% of the measurement values which trace back to neutrophil extracellular traps have a larger scattered-light intensity than the scattered-light intensity at which the limit 12 runs.

The limit 13 is chosen such that at least 80%, preferably at least 90%, particularly preferably at least 95% of the measurement values which trace back to neutrophil extracellular traps have a smaller absorptance than the absorptance at which the limit 13 runs.

In FIG. 3 and FIG. 4, the population of neutrophil extracellular traps 17 is comparatively large and the respectively associated samples have a high concentration of neutrophil extracellular traps. In FIG. 5, the population of neutrophil extracellular traps 17 is comparatively small and the associated sample has a very low concentration of neutrophil extracellular traps. The samples associated with

FIGS. 3, 4 and 5 are three human blood samples that are different from one another.

### LIST OF REFERENCE SIGNS

1 analysis system
2 light source
3 output device
4 sample of biofluid (blood sample)
5 region of selected measurement values
6 absorptance subregion
7 refractive index subregion
8 first detector
9 second detector
10 upper limit of refractive index subregion
11 lower limit of absorptance subregion
12 lower limit of refractive index subregion
13 upper limit of absorptance subregion
14 population of erythrocytes
15 population of reticulated thrombocytes
16 population of mature thrombocytes
17 population of neutrophil extracellular traps
18 capillary
A absorptance
B scattered light intensity

1. A method for detecting neutrophil extracellular traps in a sample of a biofluid, wherein a dye selective for nucleic acid is supplied to the sample of the biofluid, wherein a multiplicity of optical, particle-related measurement values is determined in the sample after staining within the absorption range of the dye, in each case as a tuple composed of a measurement value of a first optical feature and of a second optical feature, wherein measurement values of the first optical feature within a first subregion of all measured values of the first optical feature and of the second optical feature within a second subregion of all measured values of the second optical feature are selected, and wherein the number of selected measurement values is compared with a predetermined limit value in order to detect the neutrophil extracellular traps.

2. The method as claimed in claim 1, wherein the first optical feature is a scattered-light intensity or the second optical feature is a light-intensity reduction.

3. The method as claimed in claim 2, wherein the scattered-light intensity is the intensity of the light deflected by the sample by an angle within an angle range from 5 to 15 degrees.

4. The method as claimed in claims 2, wherein a refractive index is ascertained by means of the scattered-light intensity or the scattered-light intensity is used as a measure of the refractive index and wherein the refractive index is the first optical feature.

5. The method as claimed in claim 1, which is carried out in a fully automated manner in an analysis system for the optical analysis of a sample of a biofluid.

6. The method as claimed in claim 5, wherein the analysis system comprises a flow cytometer.

7. The method as claimed in claim 1, wherein an upper limit of the first subregion, which is of scattered-light intensity variable over absorptance, is chosen such that the scattered-light intensities of the neutrophil extracellular traps are separated from scattered-light intensities of reticulated thrombocytes, mature thrombocytes and erythrocytes.

8. The method as claimed in claim 1, wherein a lower limit of the second subregion, which is of absorptance variable over scattered-light intensity, is chosen such that absorptances of neutrophil extracellular traps are separated from absorptances of reticulated thrombocytes.

9. The method as claimed in claim 1, wherein absorptances of reticulated thrombocytes, mature thrombocytes, or erythrocytes are measured in the sample of the biofluid.

10. The method as claimed in claim 1, wherein refractive indices of reticulated thrombocytes, mature thrombocytes, or erythrocytes are measured in the sample of the biofluid.

11. The method as claimed in claim 1, wherein a number of selected measurement values is used for qualitative, or quantitative detection of the neutrophil extracellular traps.

12. The method as claimed in claim 1, wherein a number of selected measurement values is used for determination of a concentration of the neutrophil extracellular traps.

13. The method as claimed in claim 1, wherein the dye selective for nucleic acid is oxazine 750.

14. An analysis system for the optical analysis of a sample of a biofluid, which is setup and designed to carry out a method having the features of claim 1 in a fully automated manner.

15. The analysis system as claimed in claim 14, wherein the analysis system comprises a flow cytometer.

16. The analysis system as claimed in claim 14, wherein the sample of the biofluid comprises a blood sample.

17. The method as claimed in claim 2, wherein the second optical feature is absorptance.

18. The method as claimed in claim 2, wherein the scattered-light intensity is the intensity of the light deflected by the sample by an angle within an angle range from 5 to 8 degrees.
